(19) United States
(12) Patent Application Publication
(10) Pub. No.: US 2016/0162446 A1
(43) Pub. Date: Jun. 9, 2016

(54) ELECTRONIC DEVICE, METHOD AND STORAGE MEDIUM

(71) Applicant: KABUSHIKI KAISHA TOSHIBA, Tokyo (JP)

(72) Inventor: Takehiko Demiya, Kawasaki Kanagawa (JP)

(21) Appl. No.: 14/883,231

(22) Filed: Oct. 14, 2015

Related U.S. Application Data
(60) Provisional application No. 62/087,470, filed on Dec. 4, 2014.

(51) Int. Cl. G06F 17/21; G06F 3/16; G06F 3/0488

(52) U.S. Cl. CPC G06F 17/214; G06F 3/04883; G06F 3/167

(57) ABSTRACT

According to one embodiment, an electronic device includes circuitry. The circuitry is configured to receive stroke data corresponding to strokes input in handwriting, receive voice data corresponding to voices of speakers, and display on a screen, in a first form, a first stroke group associated with a first period in the voice data in which a first speaker speaks, and display, in a second form, a second stroke group associated with a second period in the voice data in which a second speaker speaks, the second form different from the first form.

### CROSS-REFERENCE TO RELATED APPLICATIONS

This application claims the benefit of U.S. Provisional Application No. 62/087,470, filed Dec. 4, 2014, the entire contents of which are incorporated herein by reference.

### FIELD

Embodiments described herein relate generally to an electronic device, a method and a storage medium.

### BACKGROUND

In recent years, battery-powered portable electronic devices, such as tablet computers and smartphones, have become widespread. These kinds of electronic device generally comprise a touchscreen display on which an input operation can be performed by touching the display surface. Recently, users attend meetings carrying these kinds of electronic device, and take notes by performing an input operation on a touchscreen display. In addition, most of these kinds of electronic device comprise a microphone and a speaker, and can be used as, for example, a recorder for recording and reproducing conversations in a meeting.

Incidentally, for example, it is generally hard to take notes while changing the color, the thickness, etc., of a pen by the speaker in a meeting. It is therefore hard to visually determine who spoke each matter that has been written when reviewing the notes later, for example, to prepare the proceedings of the meeting.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary illustration showing an example of an appearance of an electronic device of an embodiment.

FIG. 2 is an exemplary illustration showing an example of a handwritten document handwritten on a touchscreen display of the electronic device of the embodiment.

FIG. 3 is an exemplary illustration for explaining an example of time-series data (handwritten page data) corresponding to the handwritten document of FIG. 2, which is acquired by the electronic device of the embodiment.

FIG. 4 is an exemplary illustration showing an example of a system configuration of the electronic device of the embodiment.

FIG. 5 is an exemplary illustration for explaining an outline of a proceedings preparation support function of the electronic device of the embodiment.

FIG. 6 is an exemplary illustration for explaining a mechanism of occurrence of a lag between voice input and handwriting input.

FIG. 7 is an exemplary illustration showing functional blocks related to the proceedings preparation support function of the electronic device of the embodiment.

FIG. 8 is an exemplary illustration showing an example of an operation principle of a handwriting structuring module mounted on the electronic device of the embodiment.

FIG. 9 is an exemplary illustration showing an example of an operation principle of a voice structuring module mounted on the electronic device of the embodiment.

FIG. 10 is an exemplary flowchart showing a procedure of operation related to the proceedings preparation support function of the electronic device of the embodiment.

FIG. 11 is an exemplary illustration showing a modification of a method of displaying a handwritten document in the electronic device of the embodiment.

### DETAILED DESCRIPTION

Various embodiments will be described hereinafter with reference to the accompanying drawings.

In general, according to one embodiment, an electronic device includes circuitry. The circuitry is configured to receive stroke data corresponding to strokes input in handwriting, receive voice data corresponding to voices of speakers, and display on a screen, in a first form, a first stroke group associated with a first period in the voice data in which a first speaker speaks, and display, in a second form, a second stroke group associated with a second period in the voice data in which a second speaker speaks, the second form different from the first form.

FIG. 1 is an exemplary illustration showing an example of an appearance of an electronic device according to an embodiment. The electronic device is, for example, a portable electronic device in which a document can be input in handwriting with a pen or the like. The electronic device can store a handwritten document as one or more stroke data items indicating a time series of coordinates of sampling points of tracks of strokes such as characters, numbers, marks and figures constituting the document, not as bitmap image data, and search the handwritten document on the basis of the stroke data items. In this manner, the electronic device recognizes correspondence between stroke data and symbols (bitmap image and handwriting). The electronic device can generate a bitmap image from the stroke data on the basis of the correspondence, and thus can associate a part of a document image (character candidate region) input from a scanner, a camera or the like, with the stroke data. Thus, the electronic device can capture a document previously written in a paper notebook as stroke data.

Moreover, the electronic device can perform a character recognition process for a bitmap image indicated by part of stroke data (part of data corresponding to one symbol region), store a handwritten document also as a text comprising a character code, and search the handwritten document on the basis of the text. In this manner, the electronic device recognizes correspondence between one or more stroke data items and a character code. The electronic device can generate a bitmap image from part of stroke data corresponding to each character code on the basis of the correspondence, and thus can determine a character code of a part of a document image (character candidate region) input from a scanner, a camera or the like. Thus, the electronic device can also capture a document previously written in a paper notebook as a digital text.

The electronic device can be realized as a tablet computer, a notebook personal computer, a smartphone, a PDA, or the like. In the following description, it is assumed that the electronic device is realized as a tablet computer 1. The tablet computer 1 comprises a main body 11 and a touchscreen display 12 which enables a document to be input in handwriting. The touchscreen display 12 is mounted to be laid on a front surface of the main body 11. Various operations can be input by touching a screen of the touchscreen display 12 with the pen or a finger. A camera 13 which captures an image of a document is provided on a back surface of the main body 11. Not only documents printed or handwritten on papers but images of documents written on various analogue media such as documents printed or handwritten on a solid can be captured by capturing the images with the camera 13. In addition, a microphone 14 and speakers 15A and 15B are provided on a top surface and both side surfaces of the main body 11, respectively.

The main body 11 comprises a housing in the shape of a thin box. The touchscreen display 12 incorporates a flat panel display and a sensor configured to detect a touch position of the pen or the finger on a screen of the flat panel display. The flat panel display may be, for example, a liquid crystal display (LCD). The sensor may be, for example, a capacitive touch panel or an electromagnetic induction type digitizer. In the following description, the case where both the two kinds of sensor, the digitizer and the touch panel, are incorporated in the touchscreen display 12 will be explained.

Each of the digitizer and the touch panel is provided to cover the screen of the flat panel display. The touchscreen display 12 can detect not only a touch operation on the screen with the finger but a touch operation on the screen with the pen. The pen may be, for example, an electromagnetic induction type pen. A user can perform a handwriting input operation on the touchscreen display 12 with an external object (the pen or the finger). During the handwriting input operation, a track of movement of the external object (the pen or the finger) on the screen, that is, a track of a stroke handwritten by the handwriting input operation, is drawn in real time, whereby a track of each stroke is displayed on the screen. A track of movement of the external object made while the external object touches the screen corresponds to one stroke. A set of characters, numbers, marks, figures, etc., which is a set of handwritten strokes, constitutes a handwritten document.

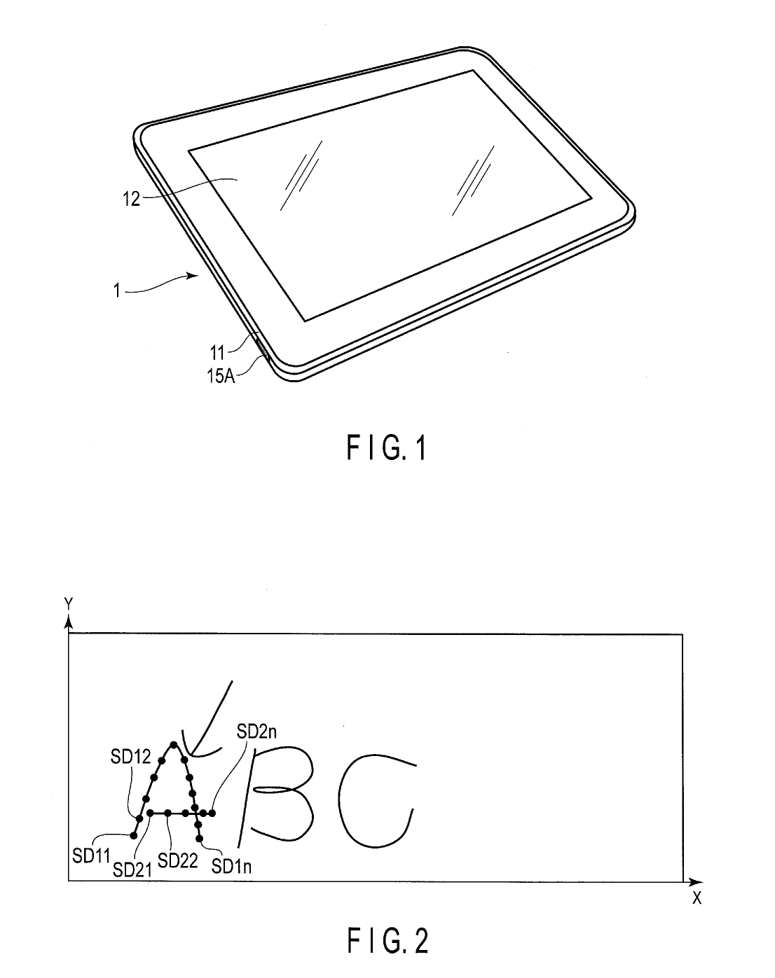

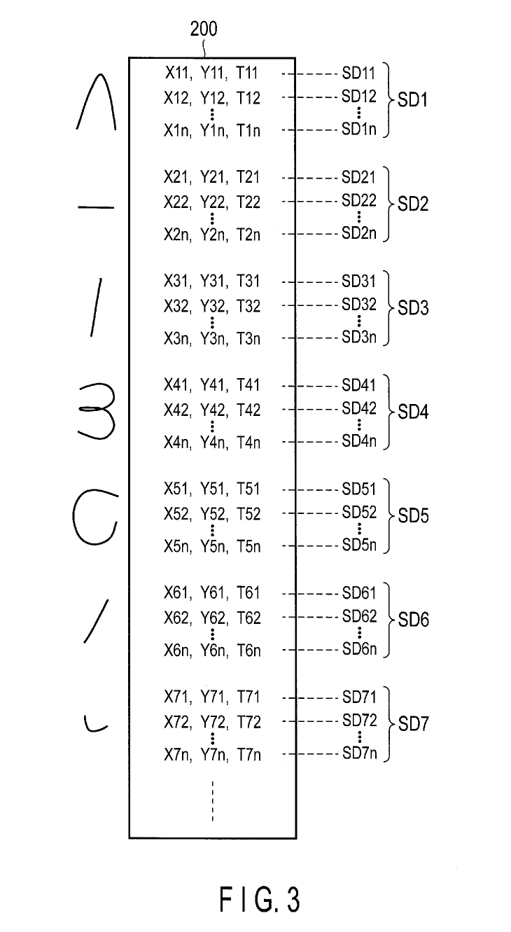

A handwritten document is stored in a storage medium as time-series data indicating a coordinate string of a track of each stroke and the order of strokes. The time-series data, which will be described later in detail with reference to FIG. 2 and FIG. 3, indicates the order in which strokes were handwritten, and includes stroke data items corresponding to the respective strokes. In other words, the time-series data means a set of time-series stroke data items corresponding to the respective strokes. Each stroke data item corresponds to one stroke, and includes a coordinate data series (time-series coordinates) corresponding to respective points on a track of the stroke. The order of these stroke data items corresponds to the order in which the respective strokes were handwritten, that is, a stroke order.

The tablet computer 1 can read arbitrary existing time-series data from the storage medium, and display a handwritten document corresponding to the time-series data, that is, tracks corresponding to respective strokes indicated by the time-series data, on the screen. Moreover, the tablet computer 1 comprises an edit function. With the edit function, an arbitrary stroke, an arbitrary handwritten character, or the like in a handwritten document that is being displayed can be deleted or moved in accordance with an edit operation by the user with an eraser tool, a range specification tool, other various tools, etc. In addition, the edit function includes a function of deleting a history of some handwriting operations. Furthermore, with the edit function, an arbitrary handwritten character, handwritten symbol, or the like can be added to a handwritten document that is being displayed.

In the embodiment, time-series data (handwritten document) can be managed as one or more pages. In this case, a set of time-series data within one screen may be stored as one page by dividing the time-series data by the area within the one screen. Alternatively, the size of a page may be changed. In this case, because the size of a page can be expanded to be larger in area than the size of one screen, a handwritten document larger in area than the size of the screen can be handled as one page. If the whole of one page cannot be displayed on the display at once, the page may be shrunk, or a portion to be displayed in the page may be moved by vertical and horizontal scrolling.

In this manner, since time-series data can be managed as page data, the time-series data will also be referred to as handwritten page data, or simply as handwritten data, in the following description.

Next, a relationship between a stroke (character, number, mark, figure, table, etc.) handwritten by the user and time-series data will be described with reference to FIG. 2 and FIG. 3. FIG. 2 shows an example of a handwritten document (handwritten character string) handwritten on the touchscreen display 12 with the pen or the like.

In a handwritten document, a case often occurs where after a character, a figure or the like is handwritten, another character, figure or the like is further handwritten thereon. In FIG. 2, a handwritten character string “ABC” is handwritten in the order of “A”, “B” and “C”, and then, a handwritten arrow is handwritten close to the handwritten character “A”.

The handwritten character “A” is represented by two strokes (a track in the shape of “A” and a track in the shape of “-”) handwritten with the pen or the like, that is, two tracks. The track “A” of the pen which is first handwritten is sampled in real time, for example, at regular time intervals, whereby time-series coordinates SD11, SD12, . . . , SD1n of the stroke “A” are obtained. Similarly, the track “-” of the pen which is next handwritten is sampled in real time at regular time intervals, whereby time-series coordinates SD21, SD22, . . . , SD2n of the stroke “-” are obtained.

The handwritten character “B” is represented by two strokes handwritten with the pen or the like, that is, two tracks. The handwritten character “C” is represented by one stroke handwritten with the pen or the like, that is, one track. The handwritten arrow is represented by two strokes handwritten with the pen or the like, that is, two tracks.

FIG. 3 shows time-series data (handwritten page data) 200 corresponding to the handwritten document of FIG. 2. The time-series data includes stroke data items SD1, SD2, . . . , SD7. In the time-series data 200, the stroke data items SD1, SD2, . . . , SD7 are chronologically arranged in a stroke order, that is, the order in which strokes were handwritten.

In the time-series data 200, the first and second stroke data items SD1 and SD2 represent the two strokes constituting the handwritten character “A”, respectively. The third and fourth stroke data items SD3 and SD4 represent the two strokes constituting the handwritten character “B”, respectively. The fifth stroke data item SD5 represents the one stroke constituting the handwritten character “C”. The sixth and seventh stroke data items SD6 and SD7 represent the two strokes constituting the handwritten arrow, respectively.

Each stroke data item includes a coordinate data series (time-series coordinates) corresponding to one stroke, that is, coordinates corresponding to respective points on a track of the one stroke. In each stroke data item, the coordinates are chronologically arranged in the order in which strokes were written. For example, regarding the handwritten character “A”, the stroke data item SD1 includes a coordinate data series (time-series coordinates) corresponding to respective points on the track of the stroke “A” of the handwritten character “A”, that is, the n coordinate data items SD11, SD12, . . . , SDln. The stroke data item SD2 includes a coordinate data series corresponding to respective points on the track of the stroke “-” of the handwritten character “A”, that is, the n coordinate data items SD21, SD22, . . . , SD2n. The number of coordinate data items may vary from stroke data item to stroke data item. The number of coordinate data items depends on the length of a stroke, because the coordinate data items are sampled in a constant cycle while the external object touches the screen.

Each coordinate data item indicates an x-coordinate and a y-coordinate corresponding to a certain point on a corresponding track. For example, the coordinate data item SD11 indicates an x-coordinate (X11) and a y-coordinate (Y11) of a start point of the stroke “Λ”. The coordinate data item SDln indicates an x-coordinate (Xln) and a y-coordinate (Yin) of an end point of the stroke “Λ”.

Furthermore, each coordinate data item may include timestamp data T corresponding to a point of time when a point corresponding to coordinates was handwritten. The point of time when the point was handwritten may be an absolute time (for example, year, month, date, hour, minute, and second) or a relative time determined with respect to a certain point of time. For example, an absolute time (for example, year, month, date, hour, minute, and second) when a stroke started being written may be added to each stroke data item as timestamp data, and a relative time indicating a difference between the relative time and the absolute time may be further added to each coordinate data item in stroke data as timestamp data T.

In this manner, a temporal relationship between strokes can be more accurately indicated by using time-series data including timestamp data T added to each coordinate data item. Thus, the accuracy of character recognition of a group comprising one or more stroke data items constituting one character can also be improved.

Moreover, data (Z) indicating writing pressure may be added to each coordinate data item. The accuracy of character recognition of a group can be further improved by also considering writing pressure.

The time-series data 200 having such a structure as described with reference to FIG. 3 can indicate not only a track of each stroke but a temporal relationship between strokes. Therefore, by using the time-series data 200, the handwritten character “A” and a tip portion of the handwritten arrow can be handled as different characters or figures, even if the tip portion of the handwritten arrow is written to be superposed on the handwritten character “A” or close to the handwritten character “A” as shown in FIG. 2.

Timestamp data of the stroke data item SD1 may be, for example, an arbitrary one selected from timestamp data items T11 to Tin corresponding to respective coordinates in the stroke data item SD1 or an average value of the timestamp data items T11 to T1n. Similarly, timestamp data of the stroke data item SD2 may be, for example, an arbitrary one selected from timestamp data items T21 to T2n corresponding to respective coordinates in the stroke data item SD2 or an average value of the timestamp data items T21 to T2n. Similarly, timestamp data of the stroke data item SD7 may be, for example, an arbitrary one selected from timestamp data items T71 to T7n corresponding to respective coordinates in the stroke data item SD7 or an average value of the timestamp data items T71 to T7n.

In the time-series data 200 of the embodiment, as described above, the order of the stroke data items SD1, SD2, . . . , SD7 indicates a stroke order of a handwritten character. For example, the order of the stroke data items SD1 and SD2 indicates that the stroke “Λ” was first written and then the stroke “-” was written. Therefore, even if two handwritten characters resemble each other in handwriting, the two handwritten characters can be distinguished from each other, provided that the stroke orders of the handwritten characters differ from each other.

Furthermore, in the embodiment, as described above, since a handwritten document is stored as the time-series data 200 comprising a set of stroke data items corresponding to strokes, handwritten characters can be handled without depending on the language of the handwritten characters. Therefore, the structure of time-series data 200 of the embodiment can be commonly used in various countries around the world where different languages are used.

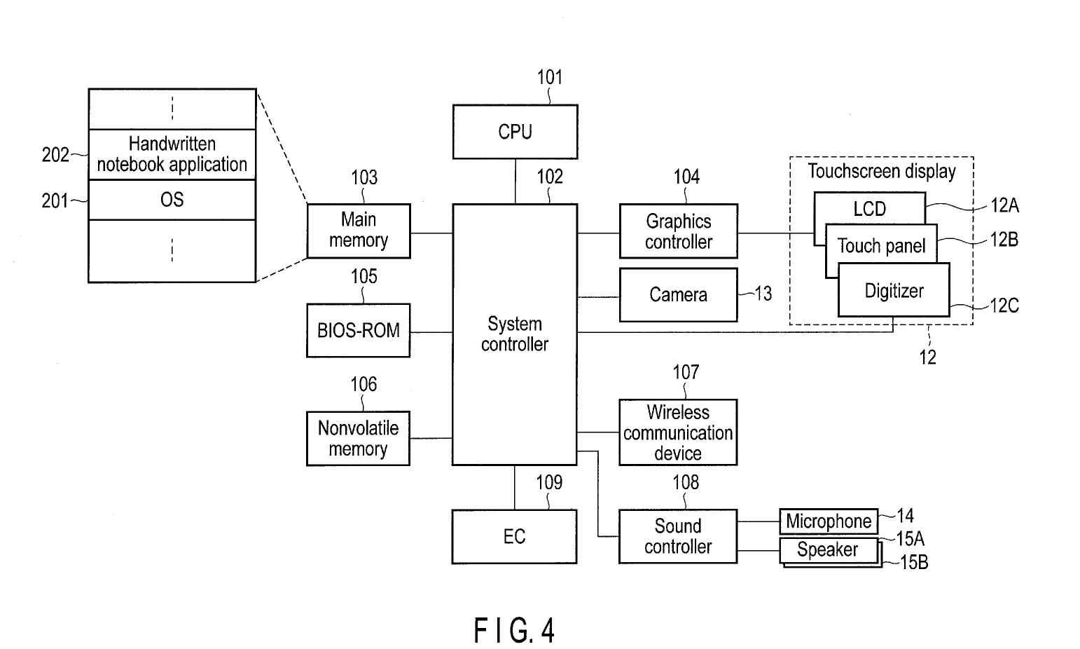

FIG. 4 is an exemplary illustration showing a system configuration of the tablet computer 1.

As shown in FIG. 4, the tablet computer 1 comprises a CPU 101, a system controller 102, a main memory 103, a graphics controller 104, a BIOS-ROM 105, a nonvolatile memory 106, a wireless communication device 107, a sound controller 108, an embedded controller (EC) 109, etc., in addition to the touchscreen display 12, the camera 13, the microphone 14, and the speakers 15A and 15B, which have been described above.

The CPU 101 is a processor which controls operation of various components in the tablet computer 1. The CPU 101 executes various kinds of software loaded from the nonvolatile memory 106, which is a storage device, to the main memory 103. The various kinds of software include an operating system (OS) 201 and various application programs. The various application programs include a handwritten notebook application program 202. The handwritten notebook application program 202 comprises a function of generating and displaying handwritten page data described above, a function of editing handwritten page data, a handwriting (stroke) retrieval function, a character recognition function, a document input function, a proceedings preparation support function, etc. The document input function is a function of inputting a document image captured by the scanner or the camera 13 as time-series data or a text. The proceedings preparation support function will be described later.

In addition, the CPU 101 also executes a BIOS stored in the BIOS-ROM 105. The BIOS is a system program for hardware control.

The system controller 102 is a device which connects a local bus of the CPU 101 and various components. The system controller 102 also contains a memory controller which exerts access control over the main memory 103. In addition, the system controller 102 also comprises a function of communicating with the graphics controller 104 through a serial bus conforming to the PCI EXPRESS standard, etc.

The graphics controller 104 is a display controller which controls an LCD 12A used as a display monitor of the tablet computer 1. The LCD 12A displays a screen image on the basis of a display signal generated by the graphics controller 104. A touch panel 12B and a digitizer 12C are disposed on the LCD 12A. The touch panel 12B is a capacitive pointing device for performing input on a screen of the LCD 12A. A touch position on the screen which the finger touches, the movement of the touch position, etc., are detected by the touch panel 12B. The digitizer 12C is an electromagnetic induction type pointing device for performing input on the screen of the LCD 12A. A touch position on the screen which the pen touches, the movement of the touch position, etc., are detected by the digitizer 12C.

The wireless communication device 107 is a device configured to perform wireless communication such as wireless LAN or 3G mobile communication.

The sound controller 108 is a sound source device, and comprises circuits such as a digital-to-analog converter which converts a digital signal into an electric signal and an amplifier which amplifies an electric signal to output voice data to be reproduced by the speakers 15A and 15B. In addition, the sound controller 108 comprises a circuit such as an analog-to-digital converter which converts an electric signal into a digital signal to input a voice signal by the microphone 14.

The EC 109 is a single-chip microcomputer including a controller for performing power management. The EC 109 comprises a function of powering on or off the tablet computer 1 in accordance with the user's operation of a power button.

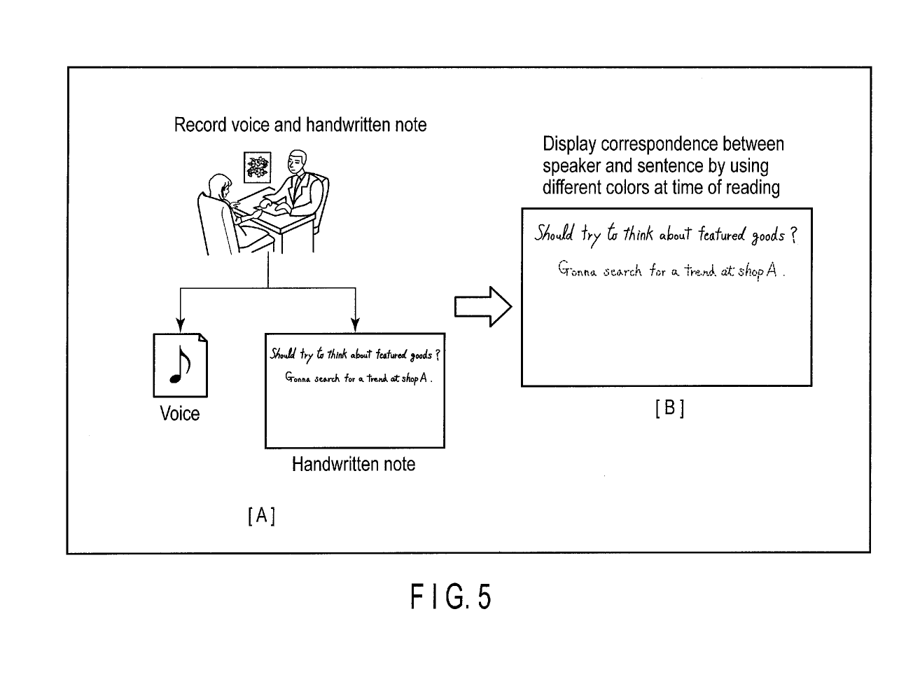

Here, an outline of the proceedings preparation support function of the tablet computer 1 (the handwritten notebook application program 202) having the above-described configuration will be described with reference to FIG. 5.

As described above, the tablet computer 1 comprises the touchscreen display 12 which enables a document to be input in handwriting and the microphone 14 which enables voice to be input. The handwritten notebook application program 202 comprises a proceedings preparation mode of operating to activate the proceedings preparation support function, and when the proceedings preparation mode is set, inputs stroke data by the touchscreen display 12 and inputs voice data by the microphone 14 as shown in FIG. 5 [A].

The handwritten notebook application program 202 associates a stroke data group which is estimated to constitute, for example, one sentence, with a speech period in voice data, using, for example, an input time of stroke data and an input time of the voice data. Moreover, the handwritten notebook application program 202 analyzes the voice data, and distinguishes speakers by the speech period. A specific method of distinguishing speakers is described in detail in, for example, Jpn. Pat. Appln. KOKAI Publication No. 2011-191824 (Japanese Patent No. 5174068), and a detailed explanation thereof is omitted herein. When it is required that a document input in handwriting in the proceedings preparation mode be read, the handwritten notebook application program 202 displays handwriting of stroke data groups which are each estimated to constitute, for example, one sentence, on the basis of a discrimination result of speakers of speech periods in the voice data which are associated with the stroke data groups, respectively, for example, using different colors as shown in FIG. 5 [B] so that the speakers can be visually distinguished. The handwriting is thereby displayed so that who spoke each matter noted down in a meeting can be easily determined. That is, the preparation of proceedings can be supported.

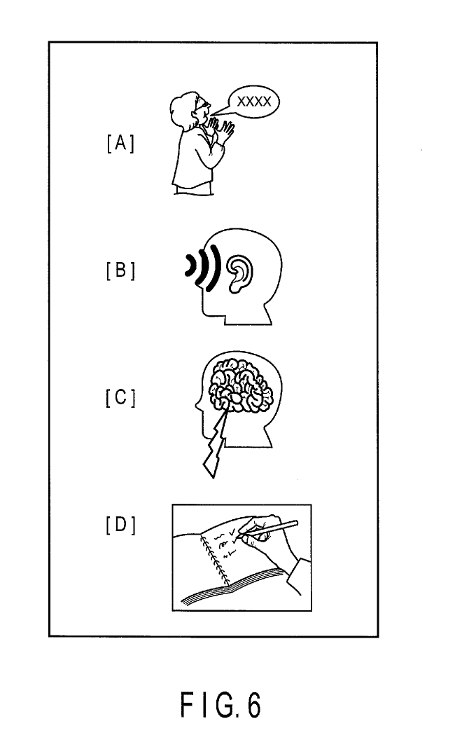

Incidentally, it should be noted that a time lag exists between a time at which a person speaks (time at which voice data is input by the microphone 14) and a time at which another person who hears the person speaking notes down its content (time at which stroke data is input by the touchscreen display 12), for example, in a meeting. A mechanism of occurrence of this lag will be described with reference to FIG. 6.

First, a speaker utters a voice (FIG. 6 [A]). The voice uttered by the speaker reaches a listener (the user of the tablet computer 1) who takes notes, and is heard by the listener through the auditory system of the listener (FIG. 6 [B]). The listener understands the content of a speech by hearing the voice of the speaker for a predetermine time period, and thinks about which matter to note down. As a result, a command to note down the matter is output from the brain (FIG. 6 [C]). The listener notes down the matter by the command (FIG. 6 [D]).

In this manner, a time lag occurs from when the speaker speaks until the listener takes notes in effect. Even if the hearing by the listener (human being) of FIG. 6 [B] is replaced with the recording by the electronic device and a time at which a voice is encoded and recorded (where a lag from when the speaker speaks occurs) is considered, a time from when a voice reaches the electronic device until it is recorded is sufficiently small in the current electronic device as compared to that took by the operations of FIG. 6 [B] to [D] performed by the human being. The time required in FIG. 6 [B] to [D] will be substantially a lag between time data of voice input and time data of handwriting input. If an input voice and a handwritten sentence are associated with each other irrespective of this lag simply on the basis of the time data of the voice input and the time data of the handwritten character, a speaker of a handwritten document is visualized with this lag included, whereby the listener feels greatly strange when making a review. The tablet computer 1 (the handwritten notebook application program 202) associates an input voice and a document input in handwriting with each other in consideration of this point.

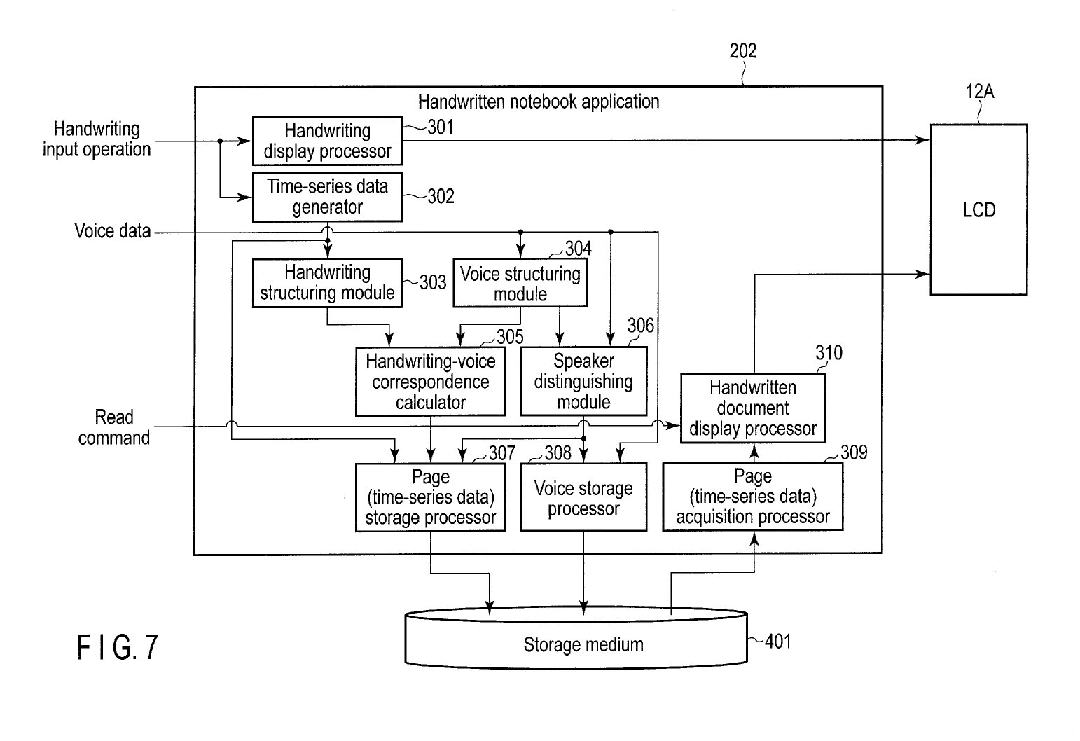

FIG. 7 is an exemplary illustration showing functional blocks related to the proceedings preparation support function of the handwritten notebook application program 202.

As shown in FIG. 7, the handwritten notebook application program 202 comprises a handwriting display processor 301, a time-series data generator 302, a handwriting structuring module 303, a voice structuring module 304, a handwriting-voice correspondence calculator 305, a speaker distinguishing module 306, a page storage processor 307, a voice storage processor 308, a page acquisition processor 309, a handwritten document display processor 310, etc.

The handwritten notebook application program 202 performs preparation, display, etc., of handwritten page data by using stroke data input on the touchscreen display 12. The touchscreen display 12 is configured to detect occurrence of events such as touch, move (slide) and release. The touch event is an event indicating that an external object has touched the screen. The move (slide) event is an event indicating that a touch position has been moved while the external object touches the screen. The release event is an event indicating that the external object has been released from the screen.

The handwriting display processor 301 and the time-series data generator 302 receive the touch or move (slide) event generated by the touchscreen display 12, thereby detecting a handwriting input operation. The touch event includes a coordinate of a touch position. The move (slide) event also includes a coordinate of the touch position which has been moved. Thus, the handwriting display processor 301 and the time-series data generator 302 can receive a coordinate string corresponding to a track of movement of the touch position from the touchscreen display 12.

The handwriting display processor 301 receives a coordinate string from the touchscreen display 12, and displays a track of each stroke handwritten by a handwriting input operation with the pen or the like on the screen of the LCD 12A in the touchscreen display 12 on the basis of the coordinate string. The handwriting display processor 301 draws a track of the pen made while the pen touches the screen, that is, a track of each stroke, on the screen of the LCD 12A.

The time-series data generator 302 receives the above-described coordinate string output from the touchscreen display 12, and generates the above-described time-series data having such a structure as described above with reference to FIG. 3 on the basis of the coordinate string.

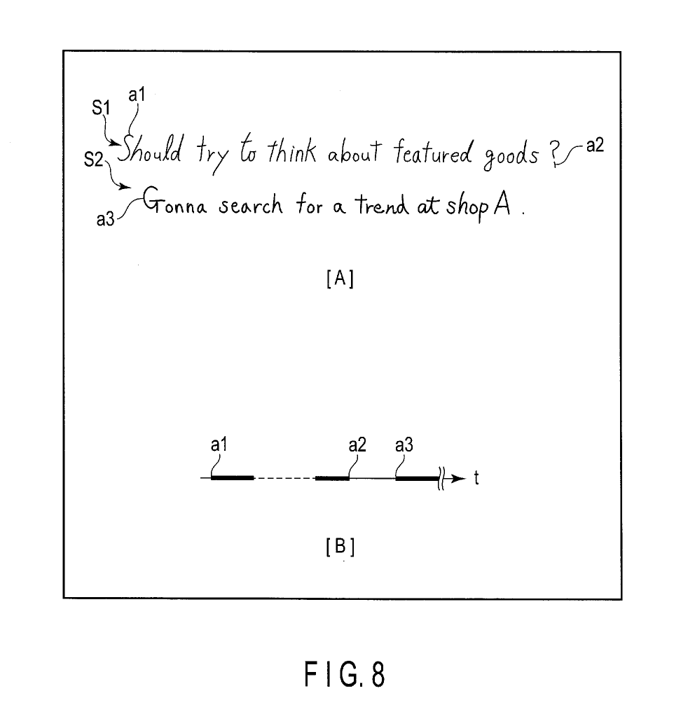

Time-series data generated by the time-series data generator 302 is supplied to the handwriting structuring module 303 and the page storage processor 307. The handwriting structuring module 303 analyzes the structure of a handwritten document comprising sentences on the basis of the time-series data. More specifically, a set of time-series stroke data items corresponding to respective strokes is classified into stroke data groups, for example, in units of sentences. An example of an operation principle of the handwriting structuring module 303 will be described with reference to FIG. 8.

As shown in FIG. 8, it is now assumed that a sentence S1, “Should try to think about featured goods?”, and a sentence S2, “Gonna search for a trend at shop A.”, are input in handwriting in accordance with statements made in a meeting (FIG. 8 [A]). Here, the sentences are first determined by the line.

In FIG. 8 [B], a time a1 indicates a handwriting input time of the one stroke of the first letter “S” in the sentence S1, and a time a2 indicates a handwriting input time of the last stroke in the two strokes of the last letter “?” in the sentence S1. Further, a time a3 indicates a handwriting input time of the first stroke in the three strokes of the first letter “G” in the sentence S2.

In one line, a distance between an end point of the last stroke of the previous character and a start point of the first stroke of the next character is short. However, if a new line is started therebetween, the distance between the end point of the last stroke of the previous character and the start point of the first stroke of the next character becomes extremely long. Therefore, the start of a new line can be recognized by determining that a new line has been started if a distance between an end point of the previous stroke and a start point of the current stroke is determined to be long. Considering that a sentence may end in the middle of a line in the case where handwriting can be performed in a fixed line direction, this distance is longer than or equal to one character, and is shorter than one line (The distance amounts to a value near a width of a handwritten region. However, since both ends of the region are scarcely used together, the distance is smaller than the width of the handwritten region).

Here, a sentence handwritten over lines will be discussed. A time lag between a time at which writing in the previous line ends and a time at which writing in the next line starts varies between the case where a sentence is continuously handwritten from the previous line and the case where the next line is started after the sentence ends. The time lag in the case where the sentence is continued is shorter. Therefore, a sentence can be estimated from this variation of a time lag, even if the sentence is handwritten over lines.

In this manner, the handwriting structuring module 303 can classify a handwritten document in units of sentences on the basis of a time and a coordinate of stroke data. An analysis result of the handwriting structuring module 303 is supplied to the handwriting-voice correspondence calculator 305.

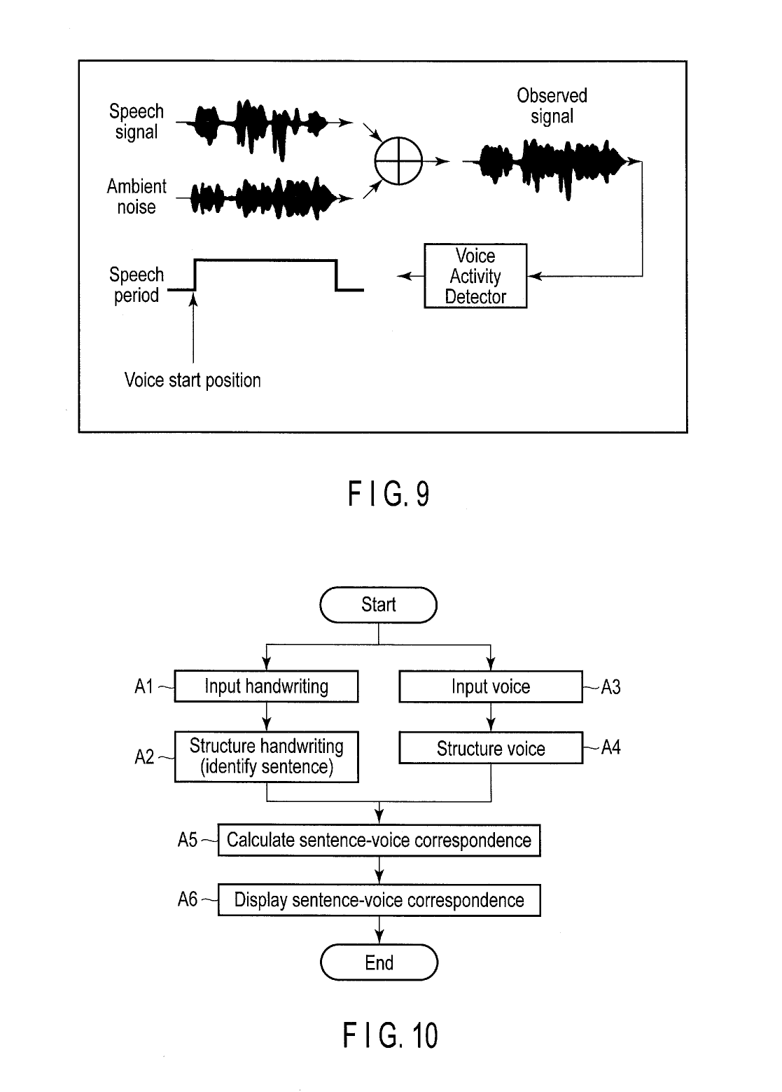

Voice data input by the microphone 14 is supplied to the voice structuring module 304, the speaker distinguishing module 306, and the voice storage processor 308. The voice structuring module 304 analyzes the voice data and detects a speech period. An example of an operation principle of the voice structuring module 304 will be described with reference to FIG. 9.

As shown in FIG. 9, not only voice signals emitted by a speaker but ambient noise signals are also superposed on voices input by the microphone 14. In general, voice signals are distributed only in a frequency region of a certain range, and have characteristic data indicating that a certain peak exists, etc. Several methods of separating voice signals having such characteristic data from noise signals have been proposed, and only the voice signals can be taken out by using such methods. Here, a speaker scarcely continues to speak ceaselessly, and in conversations, the voices of different speakers alternate, or a certain interval is placed when a topic is changed, etc., to make conversation rhythmical. Therefore, as shown in FIG. 9, although at irregular intervals, a voice start position of voice signals distributed as a temporal unit can be determined. That is, a speech period can be detected. An analysis result of the voice structuring module 304 is supplied to the handwriting-voice correspondence calculator 305 and the speaker distinguishing module 306.

The handwriting-voice correspondence calculator 305 associates a stroke data group as a sentence with a speech period in voice data on the basis of an analysis result of the handwriting structuring module 303 and an analysis result of the voice structuring module 304. The handwriting-voice correspondence calculator 305 associates, for example, a sentence which starts being input chronologically later than a start time of a certain speech period and whose input start time is the closest to the start time of the speech period, with the speech period. Then, the handwriting-voice correspondence calculator 305 associates, with the speech period, a stroke set of a sentence which starts being written by a time obtaining by adding a start time of the next speech period and a predetermined time (time from when hearing is started until a handwriting operation is started). That is, sentences can be associated with one speech period. In this case, the sentences after the first one may be, for example, associated with an input time of voice on the basis of a time calculated by subtracting a difference between an input start time of a stroke set of the first sentence associated with the same speech period and a start time of the speech period from an input start time of a stroke set of each sentence. Further, the sentences after the first one may be, for example, associated with an input time of voice on the basis of the distribution of sentences with respect to the length of the speech period. A processing result of the handwriting-voice correspondence calculator 305 is supplied to the page storage processor 307.

The speaker distinguishing module 306 analyzes voice data input by the microphone 14, and distinguishes speakers by the speech period on the basis of an analysis result of the voice structuring module 304. As described above, several methods of distinguishing speakers have been proposed, and a detailed explanation thereof is omitted herein. A processing result of the speaker distinguishing module 306 is supplied to the page storage processor 307 and the voice storage processor 308.

The page storage processor 307 stores time-series data generated by the time-series data generator 302 as handwritten page data in a storage medium 401. The storage medium 401 is a database provided in, for example, the nonvolatile memory 106, for storing handwritten page data and voice data. When storing time-series data in the storage medium 401, the page storage processor 307 stores data indicating a processing result of the handwriting-voice correspondence calculator 305 and data indicating a processing result of the speaker distinguishing module 306 as attribute data on the time-series data in the storage medium 401 at the same time.

The voice storage processor 308 stores voice data input by the microphone 14 in the storage medium 401. When storing voice data in the storage medium 401, the voice storage processor 308 stores data indicating a processing result of the speaker distinguishing module 306 as attribute data on the voice data in the storage medium 401 at the same time.

The page acquisition processor 309 reads arbitrary time-series data (handwritten page data) that has been already stored from the storage medium 401. If attribute data on time-series data to be read exists, that is, if the time-series data has been acquired in the proceedings preparation mode, the page acquisition processor 309 reads the attribute data from the storage medium 401 at the same time. The read time-series data (including the attribute data) is supplied to the handwritten document display processor 310. The handwritten document display processor 310 analyzes the time-series data, and displays handwriting which is a track of each stroke indicated by each stroke data item in the time-series data as a handwritten page on the screen on the basis of a result of the analysis. As described above, attribute data on time-series data stored in the storage medium 401 includes data indicating a processing result of the handwriting-voice correspondence calculator 305 and data indicating a processing result of the speaker distinguishing module 306. According to the attribute data, an association between a sentence and a speech period can be recognized, and a speaker of the speech period can be recognized. Thus, if attribute data exists, the handwritten document display processor 310 further performs processes, for example, distinguishing sentences by the speaker by using different colors on the basis of the attribute data. As a display method which makes the speakers visually distinguishable, not only distinguishing them by using different colors but various methods, for example, changing the thickness of characters or changing the font of characters, can be applied.

In this manner, the tablet computer 1 inputs stroke data and voice data, associates the stroke data and the voice data with each other in consideration of a time lag, and displays a handwritten document to make speakers visually distinguishable by using a result of a speaker distinguishing process for the voice data. That is, the tablet computer 1 supports the preparation of proceedings.

FIG. 10 is an exemplary flowchart showing a procedure of operation related to the proceedings preparation support function of the tablet computer 1.

The tablet computer 1 inputs stroke data corresponding to strokes input in handwriting on the touchscreen display 12 (block A1). The tablet computer 1 classifies the input stroke data into stroke data groups, for example, in units of sentences (block A2).

In addition, the tablet computer 1 inputs voice data corresponding to voices picked up by the microphone 14 while inputting the stroke data (block A3). The tablet computer 1 detects speech periods in the input voice data (block A4). At this time, the tablet computer 1 also distinguishes speakers by the speech period.

The tablet computer 1 associates the stroke data groups classified, for example, in units of sentences, with the speech periods detected from the voice data, using an input time of the stroke data and an input time of the voice data and considering a time lag between input of the stroke data and input of the voice data (block A5). In addition, the tablet computer 1 displays a handwritten document to make the speakers visually distinguishable on the basis of the association between the stroke data groups and the speech periods (block A6).

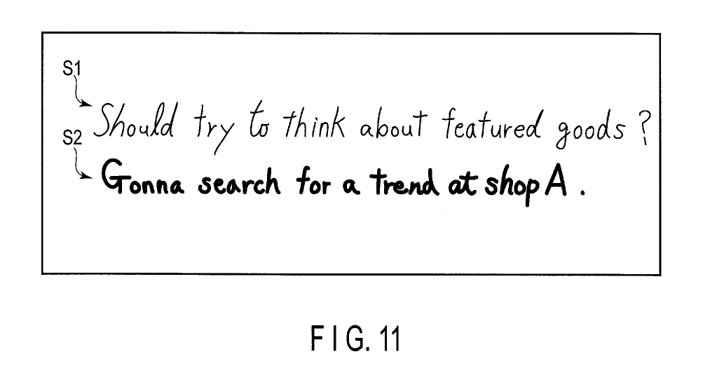

Incidentally, in the above description, an example of displaying a handwritten document in which statements made, for example, in a meeting, are noted down, distinguishing them by the speaker by using different colors, has been described. However, a method of controlling a display form of the handwritten document, using voice data, can be variously applied. For example, in the case where a speaker of a speech period associated with the sentence S1, “Should try to think about featured goods?”, and a speaker of a speech period associated with the sentence S2, “Gonna search for a trend at shop A.”, are the same person, if the volume of voice of the speech period associated with the sentence S1 is less than a threshold value while the volume of voice of the speech period associated with the sentence S2 is greater than or equal to the threshold value, the volume may be displayed to be further visually distinguishable, for example, by changing the thickness (while the colors indicating the speakers are the same) as shown in FIG. 11.

Moreover, for example, in a meeting, attendants may speak in the same period. Thus, a speech period of a single speaker and a speech period of speakers may be displayed to be further visually distinguishable.

In this manner, according to the tablet computer 1, since a handwritten document prepared, for example, in a meeting, is displayed so that speakers are visually distinguishable, the preparation of proceedings can be supported.

Various functions disclosed in the embodiment may also be each realized by a processing circuit. Examples of the processing circuit include a programmed processor such as a central processing unit (CPU). The processor executes each of the disclosed functions by executing a program stored in a memory. The processor may be a microprocessor including an electric circuit. The examples of the processing circuit also include a digital signal processor (DSP), an application specific integrated circuit (ASIC), a microcontroller, a controller, and other electric circuit components.

Because each process of each embodiment can be realized by a computer program, the same advantages as those of the embodiment can be easily achieved by installing the computer program in a normal computer through a computer-readable storage medium storing the computer program and executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising circuitry configured to:
receive stroke data corresponding to strokes input in handwriting;
receive voice data corresponding to voices of speakers; and
display on a screen, in a first form, a first stroke group associated with a first period in the voice data in which a first speaker speaks, and display, in a second form, a second stroke group associated with a second period in the voice data in which a second speaker speaks, the second form different from the first form.

2. The electronic device of claim 1, wherein the circuitry is configured to associate a stroke group in the stroke data with a period in the voice data, using an input time of the stroke data and an input time of the voice data.

3. The electronic device of claim 1, wherein:
the first period in the voice data comprises a period in which the first speaker speaks at volume less than first volume; and
the circuitry is configured to display a third stroke group associated with a third period in which the first speaker speaks at volume greater than or equal to the first volume in the voice data in a third form different from the first form.

4. The electronic device of claim 1, wherein the circuitry is configured to display a third stroke group associated with a period in which a single speaker speaks in the voice data and to display a fourth stroke group associated with a period in which speakers speak in the voice data visually distinguishable from the third stroke group.

5. A method comprising:
receiving stroke data corresponding to strokes input in handwriting;
receiving voice data corresponding to voices of speakers; and
displaying on a screen, in a first form, a first stroke group associated with a first period in the voice data in which a first speaker speaks, and displaying, in a second form, a second stroke group associated with a second period in the voice data in which a second speaker speaks, the second form different from the first form.

6. The method of claim 5, further comprising associating a stroke group in the stroke data with a period in the voice data, using an input time of the stroke data and an input time of the voice data.

7. The method of claim 5, wherein:
the first period in the voice data comprises a period in which the first speaker speaks at volume less than first volume; and
the method further comprises displaying a third stroke group associated with a third period in which the first speaker speaks at volume greater than or equal to the first volume in the voice data in a third form being different from the first form.

8. The method of claim 5, further comprising displaying a third stroke group associated with a period in which a single speaker speaks in the voice data and displaying a fourth stroke group associated with a period in which speakers speak in the voice data visually distinguishable from the third stroke group.

9. A computer-readable, non-transitory storage medium having stored thereon a computer program which is executable by a computer, the computer program controlling the computer to execute functions of:
receiving stroke data corresponding to strokes input in handwriting;
receiving voice data corresponding to voices of speakers; and
displaying on a screen, in a first form, a first stroke group associated with a first period in the voice data in which a first speaker speaks, and displaying, in a second form, a second stroke group associated with a second period in the voice data in which a second speaker speaks, the second form different from the first form.

10. The medium of claim 9, wherein the computer program further controlling the computer to execute function of associating a stroke group in the stroke data with a period in the voice data, using an input time of the stroke data and an input time of the voice data.

11. The medium of claim 9, wherein:
the first period in the voice data comprises a period in which the first speaker speaks at volume less than first volume; and
the computer program further controlling the computer to execute function of displaying a third stroke group associated with a third period in which the first speaker speaks at volume greater than or equal to the first volume in the voice data in a third form different from the first form.

12. The medium of claim 9, wherein the computer program further controlling the computer to execute function of displaying a third stroke group associated with a period in which a single speaker speaks in the voice data and displaying a fourth stroke group associated with a period in which speakers speak in the voice data visually distinguishable from the third stroke group.
